(19) United States
(12) Patent Application Publication
(10) Pub. No.: US 2006/0098245 A1
(43) Pub. Date: May 11, 2006

(54) Method and apparatus for acquiring print medium information and for controlling image printing scheme using color barcode

(75) Inventor: Min-su Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/268,737

(22) Filed: Nov. 8, 2005

(30) Foreign Application Priority Data
Nov. 9, 2004 (KR) 10-2004-0090752

(51) Int. Cl. H04N 1/04

(52) U.S. Cl. 358/474

(57) ABSTRACT

A method and apparatus for acquiring print medium information and for controlling an image printing scheme are provided. The apparatus includes a sensor sensing a color barcode containing predetermined print medium information and generating a sense signal corresponding to a color of each of the color bars constituting the color bar, a determination unit determining colors and widths of the color bars based on the sense signal, a reading unit reading out color barcode data based on the determined colors and widths of the color bars, a print medium information extraction unit extracting the print medium information based on the read-out color barcode data, and a control unit controlling an image printing scheme for the print medium based on the extracted print medium information. Print medium information is contained in a color barcode, so that it is possible to provide a large amount of print medium information in comparison to a convention barcode constructed with black and white bars. As a result, a larger amount of print medium information can be contained in a limited region of the print medium.

### CROSS-REFERENCE TO RELATED PATENT APPLICATION

This application claims the benefit under 35 U.S.C. §119(a) of Korean Patent Application No. 10-2004-0090752, filed on Nov. 9, 2004, in the Korean Intellectual Property Office, the entire disclosure of which is hereby incorporated by reference

### BACKGROUND OF THE INVENTION

1. Field of the Invention

The present invention relates to a method and apparatus for acquiring print medium information and for controlling an image printing scheme. More particularly, the present invention relates to a method and apparatus for acquiring print medium information by using a color barcode written on a print medium capable of extracting a large amount of print medium information and a method and apparatus for controlling an image printing scheme by using the method and apparatus for acquiring print medium information.

2. Description of the Related Art

Recently, a variety of printing media have been developed. Different printing media may be selected according to types of images and printers or user's preference. When printing the images on different printing media, the user must individually set up printing control schemes corresponding to the printing media. In addition, the user must set up image printing schemes according to the types of the printing media. In order to set up the image printing scheme suitable to the printing media, there is a need for information (hereinafter, referred to as “print medium information”) on the printing media.

When the print medium information is contained in a barcode written on the print medium, conventionally, the barcode is constructed with black and white bars having a predetermined pattern width. In order to be able to contain a large amount of print medium information, the conventional barcode must be constructed with long bars. Therefore, there is a need for a large barcode region when using the convention barcode. The increase in the barcode region results in a decrease in a printing region, that is, a region on which an image is printed.

### SUMMARY OF THE INVENTION

According to an embodiment of the present invention, an apparatus for acquiring print medium information by using a color barcode is provided.

According to another embodiments of the present invention, an apparatus for controlling an image printing scheme by using a color barcode is provided.

According to another embodiment of the present invention, a method for acquiring print medium information by using a color barcode is provided.

According to another embodiment of the present invention, a method for controlling an image printing scheme by using a color barcode is provided.

According to an aspect of the present invention, there is provided an apparatus for acquiring print medium information, the apparatus comprising a sensor sensing a color barcode containing predetermined print medium information and generating a sense signal corresponding to a color of each of the color bars constituting the color bar, a determination unit determining colors and widths of the color bars based on the sense signal, a reading unit reading out color barcode data based on the determined colors and widths of the color bars, and a print medium information extraction unit extracting the print medium information based on the read-out color barcode data.

In an aspect of the present invention, the print medium information extraction unit may comprise a dividing unit dividing the read-out color barcode data by predetermined print medium information parameters, and an extraction unit extracting the print medium information corresponding to the color barcode data divided by the print medium information parameters.

According to another aspect of the present invention, there is provided an apparatus for controlling an image printing scheme, the apparatus comprising a sensor sensing a color barcode containing predetermined print medium information and generating a sense signal corresponding to a color of each of the color bars constituting the color bar, a determination unit determining colors and widths of the color bars based on the sense signal, a reading unit reading out color barcode data based on the determined colors and widths of the color bars, a print medium information extraction unit extracting the print medium information based on the read-out color barcode data, and a control unit controlling an image printing scheme for the print medium based on the extracted print medium information.

According to still another aspect of the present invention, there is provided a method for acquiring print medium information comprising (a) determining colors and widths of bars constituting a color barcode containing predetermined print medium information, (b) reading out color barcode data based on the colors and widths of the color bars, and (c) extracting the print medium data based on the read-out color barcode data.

In an aspect of the present invention, operation (c) may comprise dividing the read-out color barcode data by predetermined print medium information parameters, and extracting the print medium information corresponding to the color barcode data divided by the print medium information parameters.

According to another aspect of the present invention, there is provided a method for controlling an image printing scheme, the method comprising (a) determining colors and widths of bars constituting a color barcode containing predetermined print medium information, (b) reading out color barcode data based on the colors and widths of the color bars, (c) extracting the print medium data based on the read-out color barcode data, and (d) controlling an image printing scheme for the print medium based on the extracted print medium information.

### BRIEF DESCRIPTION OF THE DRAWINGS

The above and other features and advantages of the aspects of the present invention will become more apparent by describing in detail exemplary embodiments thereof with reference to the attached drawings in which like reference numerals will be understood to refer to like parts, components and structures, where:

FIG. 1 shows a print medium according to an embodiment of the present invention, on which a color barcode is written;

FIG. 2 is a schematic view showing a construction of an image printing apparatus for printing a predetermined image on a print medium in order to explain a feeding path of the print medium;

FIG. 3 is a functional block diagram of a print medium information acquisition apparatus according to an embodiment of the present invention;

FIG. 4 shows an exemplary color barcode containing the print medium information acquired by the print medium information acquisition apparatus of FIG. 3 and color barcode data corresponding to the color barcode;

FIG. 5 shows an example of the color barcode data of FIG. 4 and the divided print medium information parameters corresponding to the color barcode data;

FIG. 6 is a functional block diagram of a printing scheme control apparatus according to an embodiment of the present invention;

FIG. 7 is a flowchart of a method of acquiring print medium information according to an embodiment of the present invention; and

FIG. 8 is a flowchart of a method of controlling an image printing scheme according to an embodiment of the present invention.

### DETAILED DESCRIPTION OF EXAMPLARY EMBODIMENTS OF THE INVENTION

An image print controlling method and apparatus will are described in detail below with reference to the accompanying drawings.

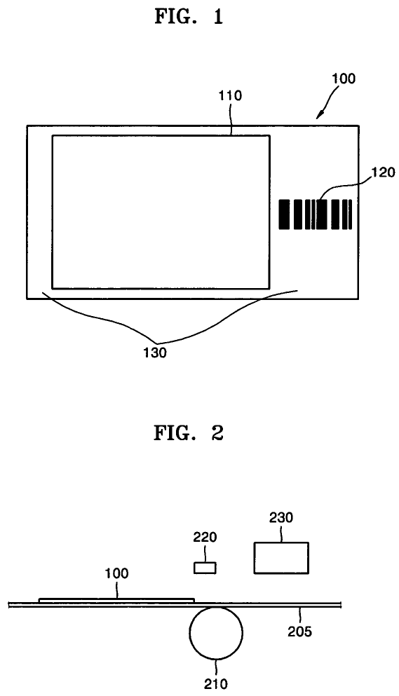

FIG. 1 shows a print medium 100 according to an embodiment of the present invention, on which a color barcode is written. The print medium 100 includes a printing region 110 on which an image is printed and an edge region 130 having a color barcode 120. The color barcode 120 contains information (hereinafter, referred to as “print medium information”) on the print medium 100. The color barcode 120 includes bars in various colors. A predetermined image is printed on the printing region 110. The printing region 110 and the edge region 130 are separated from each other, so that the image can be printed on the only printing region 110. For example, the print medium 100 may be a print medium capable of expressing colors such as yellow, magenta, and cyan by heat applied thereto.

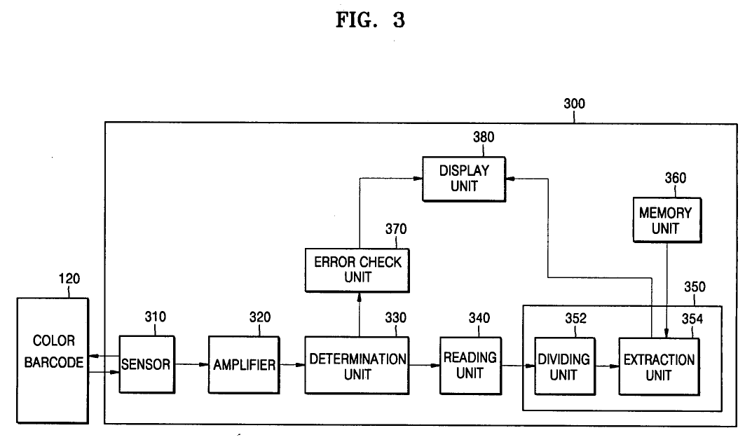

FIG. 2 is a schematic view showing a construction of an image printing apparatus for printing a predetermined image on the print medium 100 of FIG. 1. FIG. 2 also exemplifies a feeding path of the print medium 100 as follows. The print medium 100 mounted on a feed rope 205 coupled with a feed roller 210 is fed toward a barcode sensor 220. The color barcode 120 containing the print medium information is written on the edge region 130 of the print medium 100. When the predetermined image is printed on the print medium 100, the print medium information contained in the color barcode 120 is extracted by the barcode sensor 220. Next, a thermal printer head prints the image based on the print medium information extracted by the barcode sensor 220.

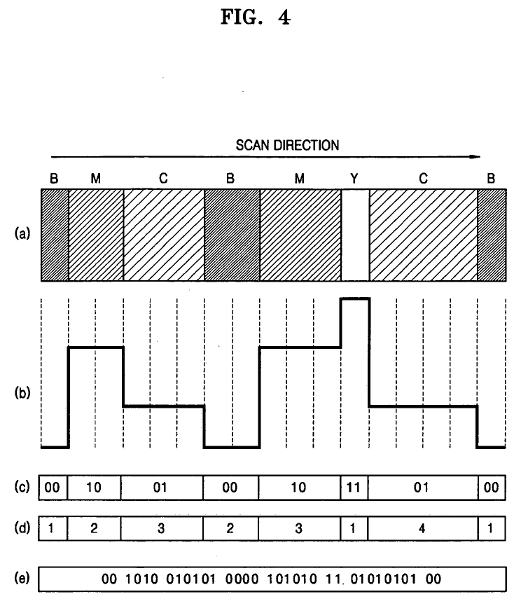

FIG. 3 is a functional block diagram of a print medium information acquisition apparatus 300 according to an embodiment of the present invention. The print medium information acquisition apparatus 300 includes a sensor 310, an amplifier 320, a determination unit 330, a reading unit 340, a print medium information extraction unit 350, a memory unit 360, an error check unit 370, and a display unit 380.

The sensor 310 includes a light projecting unit (not shown) and a light receiving unit (not shown). The light projecting unit projects a predetermined light such as a white light on the color barcode 120 written on the print medium 100. The light receiving unit receives light reflected from the color barcode 120 and generates an electrical signal corresponding to an intensity of the received light. The amplifier 320 amplifies the generated electrical signal and provides the amplified signal to the determination unit 330.

The determination unit 330 determines colors of the color bars of the color barcode in a predetermined feed interval of the print medium 100. The feed interval is, for example, 1/48000 inches. The colors and widths of the color bars are determined by counting the number of the color bars having the determined colors. The color barcode includes color bars such as yellow, magenta, cyan, and black color bars. A color of each color bar is determined according to a threshold value of the electrical signal corresponding to each color. Namely, if an electrical signal generated by the sensor 310 is smaller than a first threshold value, the color of the corresponding color bar is determined to be black, a color level of which is 0. If an electrical signal is larger than the first threshold value and smaller than a second threshold value, the color of the corresponding color bar is determined to be cyan, a color level of which is 1. If an electrical signal is larger than the second threshold value and smaller than a third threshold value, the color of the corresponding color bar is determined to be magenta, a color level of which is 2. If an electrical signal is larger than the third threshold value and smaller than a fourth threshold value, the color of the corresponding color bar is determined to be yellow, a color level of which is 3. In some application, other colors may be used instead of the colors of the color bars constituting the color barcode according to the embodiment of the present invention, but other colors are also within the scope of the present invention.

The reading unit 340 reads out color barcode data based on widths and colors of the color bars determined by the determination unit 330. The print medium information extraction unit 350 includes a dividing unit 352 and an extraction unit 354 to extract the print medium information based on the read-out color barcode data. The dividing unit 352 divides the color barcode data read out by the reading unit 340 by predetermined print medium information parameters. The extraction unit 354 extracts from the memory unit 360 the print medium information corresponding to the color barcode data divided by the print medium information parameters. According to an exemplary implementation, a memory unit 360 stores the print medium information corresponding to the color barcode data divided by the print medium information parameters. The print medium information includes, for example, information on types, sizes, and versions of the print medium and print control information corresponding to the types and versions of the print medium.

The error check unit 370 checks an extraction error, that is, a reading error for the print medium information based on the number of color bars corresponding to the widths and colors of the color bars in a predestined pattern. For example, a color barcode may be represented with three 1 mm-width bars, two 2 mm-width bars, two 3 mm-width bars, and one 4 mm-width bar. In this case, if the numbers of the 1 mm-, 2 mm-, 3 mm-, and 4 mm-width bars are determined to be 3, 2, 2, and 1, respectively, by the determination unit 330, the error check unit 370 verifies that there is no error in the extracted print medium information.

The display unit 380 displays predetermined print medium information and an error check result to a user.

FIG. 4 shows an exemplary color barcode containing the print medium information and color barcode data corresponding to the color barcode. In FIG. 4, (a) shows the color barcode written on a print medium. The color barcode is scanned by the sensor 310 moving in a predetermined scan direction, for example, leftwards as indicated by the arrow in the figure. In FIG. 4, (b) shows color levels of color bars (determined by the determination unit 330 based on the electrical signal generated by the sensor 310 corresponding to the intensity of the light reflected from the color bars). For example, color levels of 0, 1, 2, and 3 may be allocated to black, cyan, magenta, and yellow color bars. In addition, corresponding data is allocated to each color level. In FIG. 4, (c) shows the data 00, 01, 10, and 11 allocated to the color levels 0, 1, 2, and 3, respectively. In some application, other allocation methods for the color levels and the data may be used, but these methods are within the scope of the present invention. In FIG. 4, (d) shows widths of color bars determined by the determination unit 330, and (e) shows the color barcode data read out from the color barcode based on the colors and widths of the determined color bars.

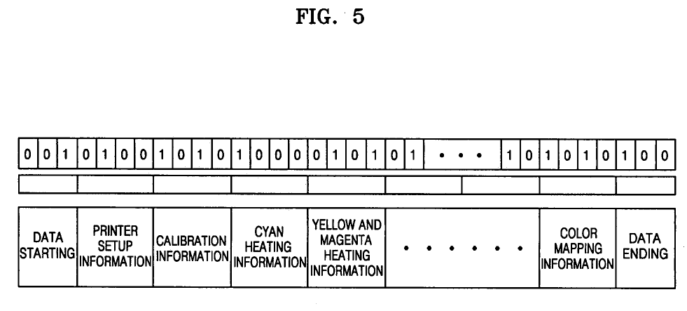

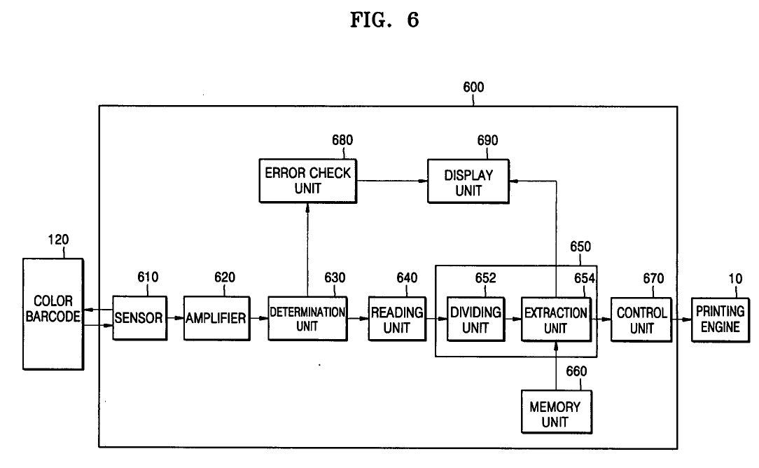

FIG. 5 shows the color barcode data and the divided print medium information parameters. As shown in the figure, the color barcode data is divided by predetermined print medium information parameters. First and last few bits of the color barcode data are allocated to data starting and ending parameters for indicating starting and ending points of the color barcode data. Other data bits are allocated as image printing apparatus setup information, calibration information, color (cyan, yellow, and magenta) heating information, and color mapping formation parameters.

FIG. 6 is a functional block diagram of an image printing control apparatus 600 according to an embodiment of the present invention. The image printing control apparatus 600 includes a sensor 610, an amplifier 620, a determination unit 630, a reading unit 640, a print medium information extraction unit 650, a memory unit 660, a control unit 670, an error check unit 680, and a display unit 690. The sensor 610, the amplifier 620, the determination unit 630, the reading unit 640, the print medium information extraction unit 650, the memory unit 660, the error check unit 680, and the display unit 690 have the same functions as the sensor 310, the amplifier 320, the determination unit 330, the reading unit 340, the print medium information extraction unit 350, the memory unit 360, the error check unit 370, and the display unit 380 of FIG. 3. Therefore, the print medium information is acquired by using the sensor 610, the amplifier 620, the determination unit 630, the reading unit 640, the print medium information extraction unit 650, and the memory unit 660.

The control unit 670 controls a printing engine 10 based on the acquired print medium information. The printing engine 10 prints a predetermined image on the print medium with the most suitable printing scheme under the control of the control unit 670.

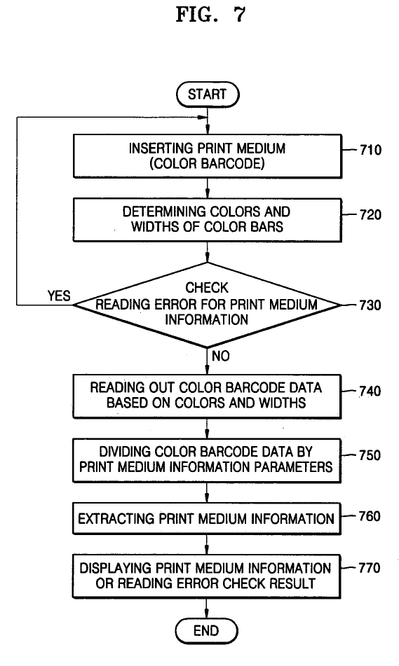

FIG. 7 is a flowchart of a method of acquiring print medium information according to an embodiment of the present invention. A print medium on which a color barcode is written is inserted into a print medium information acquisition apparatus in step 710. Colors and widths of color bars constituting the color barcode is sensed and determined by a barcode sensor in step 720. More specifically, the barcode sensor projects a predetermined light on the color bars of the barcodes and receives light reflected from the color bars. An electrical signal corresponding to an intensity of the reflected light is generated, and the colors and widths of the color bars are determined based on the size of the electrical signal. While the inserted print medium is fed in a constant feed interval, color levels of the color bars are determined according to the electrical signals generated at the feed intervals. In addition, the widths of the color bars are determined by counting the number of feed intervals of the print medium.

Next, a reading error for the print medium information is checked based on the number and width of the color bars constituting the color barcode in step 730. As an error check result, if there is no error, color barcode data is read out based on the determined colors and widths of the color barcode in step 740.

Next, the print medium information is extracted based on the read-out color barcode data in steps 750 and 760. More specifically, the read-out color barcode data is divided into predetermined print medium information parameters in step 760. The print medium information corresponding to the color barcode data divided by the print medium information parameters is extracted in step 770. On the other hand, if it is verified in step 730 that there is a reading error for the print medium information, the process returns to step 710. The extracted print medium information or the error check result is displayed on a display unit in step 770.

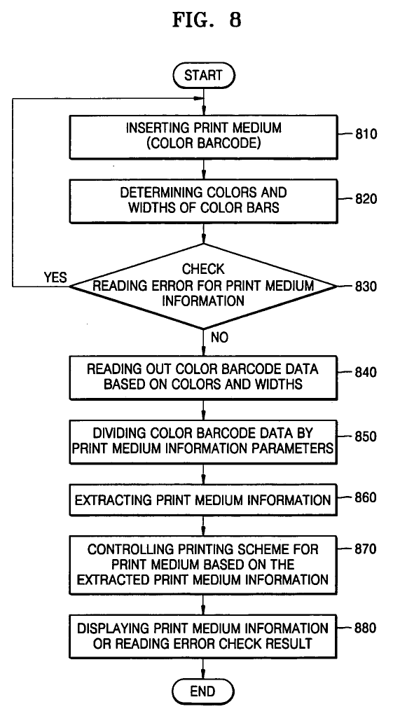

FIG. 8 is a flowchart of a method of controlling an image printing scheme according to an embodiment of the present invention. Operations performed in step 810 to 860 and 880 are analogous to the operations performed in steps 710 to 770, respectively. Therefore, description of operations performed in step 810 to 860 and 880 is omitted for conciseness.

After operation 860, a printing scheme for printing a predetermined image on the print medium is controlled in step 870. The extracted print medium information includes, for example, information on a size, type, and version of the print medium and printing control information according to the type and version of the print medium. The printing scheme for the print medium is controlled based on the extracted print medium information.

According to a method and apparatus, for acquiring print medium information and for controlling an image printing scheme, of the present invention, print medium information is contained in a color barcode, so that it is possible to provide a large amount of print medium information in comparison to a convention barcode constructed with black and white bars. As a result, a larger amount of print medium information can be contained in a limited region of the print medium.

Exemplary embodiments of the present invention can be configured in a computer programs and can be implemented in general-use digital computers that execute the programs using a computer readable recording medium. Examples of the computer readable recording medium include magnetic storage media (for example, ROM, floppy disks, hard disks, and so forth), optical recording media (for example, CD-ROMs, or DVDs), and storage media such as carrier waves (for example, transmission through the Internet).

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of acquiring print medium information, the method comprising:
determining colors and widths of bars of a color barcode comprising print medium information;
reading color barcode data based on the colors and widths of the color bars; and
extracting the print medium information based on the read color barcode data.

2. The method according to claim 1, wherein the determining of the colors and widths comprises:
projecting a light on the color barcode moving at an interval;
receiving light reflected from the color barcode;
generating a signal corresponding to a magnitude of the received light; and
determining the colors and widths of the color bars based on the generated signal.

3. The method according to claim 1, wherein the extracting of the print medium information comprises:
dividing the read color barcode data using print medium information parameters; and
extracting the print medium information corresponding to the color barcode data divided using the print medium information parameters.

4. The method according to claim 1, further comprising, after the determining of the colors and widths, checking a reading error for the print medium information based on the number of a color bar comprising a width or color pattern.

5. The method according to claim 4, further comprising, after the extracting of the print medium information, displaying at least one of the print medium information and the reading error check result.

6. The method according to claim 1, wherein the print medium information comprises at least one of information on a type and version of the print medium and print control information corresponding to the type and version of the print medium.

7. A method of controlling an image printing scheme, the method comprising:
determining color and width of at least on bar of a color barcode comprising print medium information;
reading color barcode data based on the colors and widths of the color bars;
extracting the print medium information based on the read color barcode data; and
controlling an image printing for the print medium based on the extracted print medium information.

8. The method according to claim 6, wherein the determining of the colors and widths comprises:
projecting a light on the color barcode moving at an interval;
receiving light reflected from the color barcode;
generating a signal corresponding to a magnitude of the received light; and
determining the colors and widths of the color bars based on the generated signal.

9. The method according to claim 6, wherein the extracting of the print medium information comprises:
dividing the read color barcode data using print medium information parameters; and
extracting the print medium information corresponding to the color barcode data divided using the print medium information parameters.

10. A computer-readable medium having embodied thereon a computer program comprising:
executable instructions for determining colors and widths of color bars of a color barcode comprising print medium information;
executable instructions for reading color barcode data based on the colors and widths of the color bars; and
executable instructions for extracting the print medium information based on the read color barcode data.

11. An apparatus for acquiring print medium information, the apparatus comprising:
a sensor sensing a color barcode comprising print medium information and generating a sense signal corresponding to a color of each of the color bars of the color bar;
a determination unit determining color and widths of the color bars based on the sense signal;
a reading unit reading color barcode data based on the determined colors and widths of the color bars; and
a print medium information extraction unit extracting the print medium information based on the read color barcode data.

12. The apparatus according to claim 11, wherein the print medium information extraction unit comprises:
a dividing unit dividing the read color barcode data using print medium information parameters; and
an extraction unit extracting the print medium information corresponding to the color barcode data divided into the print medium information parameters.

13. The apparatus according to claim 12, further comprising a memory unit storing the print medium information corresponding to the color barcode data divided using the print medium information parameters.

14. The apparatus according to claim 11, further comprising an error check unit checking a reading error for the print medium information based on the number of a color bar comprising a width or color pattern.

15. The apparatus according to claim 11, further comprising a display unit displaying at least one of the print medium information and the reading error check result.

16. The apparatus according to claim 11, wherein the print medium information comprises at least one of information on a type and version of the print medium and print control information corresponding to the type and version of the print medium.

17. An apparatus for controlling an image printing scheme, the apparatus comprising:
a sensor sensing a color barcode comprising print medium information and generating a sense signal corresponding to a color of each of the color bars of the color bar;
a determination unit determining colors and widths of the color bars based on the sense signal;
a reading unit reading color barcode data based on the determined colors and widths of the color bars;
a print medium information extraction unit extracting the print medium information based on the read color barcode data; and
a control unit controlling an image printing scheme for the print medium based on the extracted print medium information.

18. The apparatus according to claim 17, wherein the print medium information extraction unit comprises:
a dividing unit dividing the read color barcode data using print medium information parameters; and
an extraction unit extracting the print medium information corresponding to the color barcode data divided using the print medium information parameters.

19. The apparatus according to claim 18, further comprising a memory unit storing the print medium information corresponding to the color barcode data divided using the print medium information parameters.

20. The apparatus according to claim 17, further comprising an error check unit checking an reading error for the print medium information based on the number of a color bar comprising width or color pattern.

21. The apparatus according to claim 17, further comprising a display unit displaying at least one of the print medium information and the reading error check result.

22. The apparatus according to claim 17, wherein the print medium information comprises at least one of information on a type and version of the print medium and print control information corresponding to the type and version of the print medium.
